(19) United States
(12) Patent Application Publication
(10) Pub. No.: US 2017/0272470 A1
(43) Pub. Date: Sep. 21, 2017

(54) SYSTEMS AND METHODS FOR INTELLIGENT TRANSPORT LAYER SECURITY

(71) Applicant: Affirmed Networks, Inc., Acton, MA (US)

(72) Inventors: Krishna GUNDAMARAJU, Westborough, MA (US); Srinivasan VENKATRAMAN, Belmont, MA (US); Piotr GALECKI, Lexington, MA (US)

(21) Appl. No.: 15/460,495

(22) Filed: Mar. 16, 2017

Related U.S. Application Data
(60) Provisional application No. 62/309,186, filed on Mar. 16, 2016.

(51) Int. Cl. H04L 29/06; H04L 29/08

(52) U.S. Cl. CPC H04L 63/20; H04L 67/2857; H04L 63/166; H04L 63/0281; H04L 61/6009

(57) ABSTRACT

Systems and methods for detecting a domain name in a mobile network session for use in applying mobile policy and enforcement functions based on the domain name. A computing device receives a packet associated with a request from a user equipment to access a domain at a server. The computing device determines a traffic type associated with the packet, the traffic type including one of Hypertext Transfer Protocol (HTTP) traffic, Hypertext Transfer Protocol Secure (HTTPS) traffic, and non HTTP or HTTPS traffic. The computing device determines a domain name based on the traffic type and determines a service to apply to the packet based on the domain name.

### CROSS REFERENCE TO RELATED APPLICATIONS

This application claims priority to U.S. Provisional Application No. 62/309,186, filed Mar. 16, 2016, which is incorporated herein by reference.

### TECHNICAL FIELD

Embodiments of the invention generally relate to computerized methods and apparatuses for determining domain names associated with mobile sessions between an end user and a server.

### BACKGROUND

In mobile networks, including both cellular and Wi-Fi access networks, it has become difficult to enforce policy enforcement functions on Hypertext Transfer Protocol Secure (HTTPS) traffic. A significant portion of traffic today is conducted over HTTPS. With Hypertext Transfer Protocol (HTTP) traffic, access gateways like packet gateways (PGWs) and wireless application gateways (WAGs) can determine the destination network domain name by parsing the HTTP host headers and applying different policy enforcement charging and quality of service (QoS) semantics for different domains. After the migration to HTTPS, which includes digital certificates to secure data, gateways cannot decrypt the encrypted traffic unless the content provider installs digital certificates in the gateway. That is, gateways have no visibility into a HTTP host header.

To handle HTTPS, transport layer security (TLS) protocol fields like server name indication (SNI) and Server Common Name (CName) are used to identify the domain the user is trying to access. However, most content providers use a mechanism called session resumption where the Common Name is not always seen in the transactions. The session resumption usually includes an abbreviated TLS handshake mechanism that renders any solution based on Common Name to be inaccurate. In this mechanism the client and server do not exchange digital certificates and instead they use a shared secret that has been exchanged between the same two end points during an earlier full TLS handshake. Intermediate gateways cannot match on the fields in digital certificates for abbreviated TLS sessions as a certificate is not exchanged during the abbreviated TLS handshake. That is, there is no solution known that is accurate in detecting all TLS sessions (HTTPS traffic).

Gateways in cellular and Wi-Fi networks also have the need apply certain services like free rating, high bandwidth, steering to dedicated servers, load balancing across servers for both HTTP and HTTPS (HTTP over SSL) traffic. When traffic is encrypted it can be difficult to free rate the traffic for a certain domain reliably and it can be difficult to selectively steer only traffic to certain HTTPS domains to a dedicated server.

### SUMMARY OF THE INVENTION

Systems and methods are described herein for detecting a domain name in a mobile network session for use in applying mobile policy and enforcement functions based on the domain name. In some embodiments, the systems and methods include receiving a packet associated with a request from a user equipment to access a domain at a server. In some embodiments, the systems and methods include determining a traffic type associated with the packet, the traffic type including one of Hypertext Transfer Protocol (HTTP) traffic, Hypertext Transfer Protocol Secure (HTTPS) traffic, and non HTTP or HTTPS traffic. In some embodiments, the systems and methods include determining a domain name based on the traffic type, wherein determining the domain name comprises extracting a domain name from a host header in the packet when the traffic type comprises HTTP traffic, extracting at least one of a server name indication (SNI) and a server common name from the packet to determine a domain name when the traffic type comprises HTTPS traffic, and extracting a destination IP address from the packet, and using the destination IP address to determine a matching domain name in a DNS reverse cache when the traffic type comprises non HTTP or HTTPS traffic. In some embodiments, a service to apply to the packet is determined based on the domain name.

In some embodiments, an association is stored between the domain name with at least one of an Internet Protocol (IP) address, and a transport layer security session ID. In some embodiments, the systems and methods include applying deep packet inspection to the packet to determine the traffic type, and transmitting a loopback address to the user equipment indicative of the domain name. In some embodiments, the service comprises at least one of a quality of service (Qos), charging semantics, and metering semantics. In some embodiments, non HTTP or HTTPS traffic comprises at least one of Internet Control Message Protocol (ICMP) traffic, User Datagram Protocol (UDP) traffic, and non-HTTP protocols using Transmission Control Protocol (TCP) traffic. In some embodiments, to determine the domain name when the traffic type comprises HTTPS traffic, a handshake status between the user equipment and the server is determined, the handshake status including one of a full handshake and an abbreviated handshake. In some embodiments, when the handshake status comprises a full handshake at least one of the SNI and the server common name is extracted from the packet to determine the domain name. In some embodiments, when the handshake status comprises an abbreviated handshake, the SNI is extracted from the packet when the SNI is available. In some embodiments, when the SNI is not available, the server common name is determined by extracting a session ticket associated with the request, and comparing the session ticket with a previously generated session ticket created during a previous full handshake between the user equipment and the server, the previously generated session ticket associated with the server common name.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is a system diagram showing a networked system 100, according to some embodiments.

FIG. 2 is a flow diagram showing a TLS message flow between UE and an HTTP server during a full handshake, according to some embodiments of the present disclosure.

FIG. 3 is a flow diagram showing a TLS message flow between UE and an HTTP server during an abbreviated handshake, according to some embodiments of the present disclosure.

FIG. 4 is a flow diagram showing a DNS request and response that a host exchanges for domain name resolution, according to some embodiments of the present disclosure.

FIG. 5 is a flow diagram showing a combination of DNS reverse caching, TLS domain detection, and deep packet inspection techniques to handle resumed sessions, according to some embodiments of the present disclosure.

FIG. 6 is a flow diagram showing service differentiation TCP splicing, according to some embodiments, of the present disclosure.

FIG. 7 shows a flowchart of detecting a domain name in a mobile network session to apply a service to the session, according to some embodiments of the present disclosure.

### DETAILED DESCRIPTION

Some embodiments of the systems and methods described herein provide for a deep packet inspection mechanism on a packet core network that provides wireless operators with an ability to apply policy enforcement functions such as QoS, charging, content filtering, redirection, and steering based on domain names. The mechanism allows rules to be defined to match on any of the fields that are exchanged in a TLS handshake. This includes matching an SNI field, which is exchanged in a Client Hello message, and a common name field that is specified in a certificate message from the server. This mechanism can also be extended to other fields in digital certificates, for example subject alternative name (SAN), server-country-name and server-organization name. In some embodiments, a TLS session cache is maintained on the access gateway, which is used to store the TLS session ID for certificate fields mapping. When a gateway detects a full TLS handshake with a non-zero TLS session id, the gateway stores the mapping between the TLS session ID to certificate field names (e.g., a server common name) in this cache. At a later point in time, when the same endpoints go through an abbreviated TLS handshake using the session ID that was earlier exchanged in a full handshake, the gateway can identify the exchange as occurring between the same endpoints, retrieve the certificate fields that correspond to the session ID, and use the extracted fields for rule matching.

Some embodiments of the systems and methods described herein provide for domain name system (DNS) reverse caching. The reverse cache can be created by snooping DNS responses, extracting internet protocol (IP) to domain(s) mapping from the responses, and installing the mappings into a DNS reverse cache. For a new protocol (e.g., HTTPS) connection the domain is initially determined by matching an IP address to a domain in a DNS reverse cache. The decision can later be refined by using TLS domain detection. For TLS transactions, a mobile content cloud (MCC) can determine the domain by matching either on the SNI information in the Client Hello message or the Server common name message that is sent by the Server in the Certificate message. DNS reverse caching and TLS domain detection can be recombined with the deep packet inspection mechanism described above to handle resumed sessions. The DNS reverse cache mechanism allows for initial packet classification (when TLS handshake data is not yet available) with later refinement based on TLS derived domain for accurate domain determination.

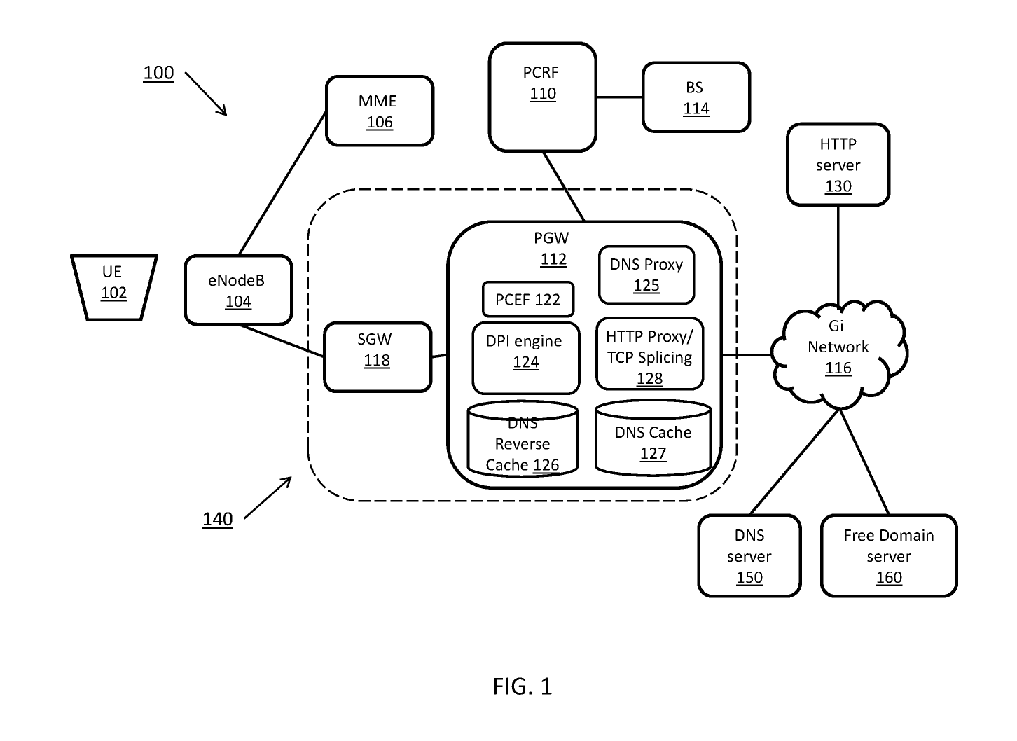

FIG. 1 is a system diagram showing a networked system 100, according to some embodiments of the present disclosure. System 100 includes user equipment (UE) 102, evolved node B (eNodeB) 104, mobile management entity (MME) 106, policy and charging rules function (PCRF) 110, backend billing system (BS) 114, mobile content cloud (MCC) 140, gigabit wireless (Gi) network 116, and HTTP server 130. MCC 140 includes serving gateway (SGW) module 108 and packet data network gateway (PGW) 112. Packet data network gateway (PGW) 112 includes policy and charging enforcement function (PCEF) 122, a DPI engine 124, domain name system (DNS) reverse cache 126, DNS proxy 125, DNS cache 127, HTTP Proxy/TCP Splicing 128, and Free Domain server 160.

UE 102 connects to the networked system 100 through eNodeB 104. UE 102 includes computing devices configured to connect to a mobile data network (e.g., mobile phones, tablets, laptops). eNodeB 104 is a radio part of a cell site. A single eNodeB 104 may contain several radio transmitters, receivers, control sections and power supplies. eNodeB 104 can be backhauled to MME 106 and SGW 108. Backhaul is a process of transferring packets or communication signals over relatively long distances to a separate location for processing. SGW 108 routes and forwards user data packets, while also acting as the mobility anchor for a user plane during inter-eNodeB handovers. MME 106 is a control node in the networked system 100. MME 106 handles the LTE related control plane signaling that also includes mobility and security functions for UE 102 that attaches to the LTE Radio network. MME 106 also handles UE being in idle mode, including support for Tracking area management and paging procedures.

When a UE 102 attaches to the network, multiple control messages are exchanged between network elements to create a data session (e.g., a 4G session) and provide data connectivity to the UE 102. As explained above, eNodeB 104 can be backhauled to MME 106 and SGW 108. SGW 108 routes and forwards user packets to PGW 112. PGW 112 can act as a Policy Enforcement Point (PEP). PGW 112 communicates with PCRF 110, which can download policy information that is specific to a subscriber. PCRF acts as a Policy Decision Point (PDP). At the time of session creation, PCRF 110 can request PGW 112 to track usage information for a specific session and inform PCRF 110 when a usage threshold is reached. Usage information can include an allotted quota corresponding to UE 102 (e.g., mobile data credit amount) and can be configured to a set amount. In some embodiments, PCRF can be connected to a backend billing system (BS) 114. BS 114 can communicate user billing information to PCRF 110.

In some embodiments, PGW 112 can include PCEF 122. PCEF 122 enforces policy decisions received from PCRF 110. PGW 112 also provides UE 102 with connections to external packet data networks (e.g., HTTP server 130, DNS server 150, free domain server 160) through Gi Network 116. Briefly, HTTP server 130 is a server that processes requests via HTTP and stores, processes and delivers web pages to clients. DNS server 150 translates domain name requests into IP addresses and uses the IP address to locate network resources. Free domain server 160, as described in more detail, refers to a server that processes transactions to free-rated sites. Free-rated sites are sites that are accessible over a network regardless of a user's mobile usage quota.

PGW 112 can also include DPI engine 124 and DNS Reverse Cache 126. Deep packet inspection engine 124 uses deep packet inspection to detect elements of a packet such as protocol and session ID. As described in more detail below, deep packet inspection engine can extract elements of a packet (e.g., session ID) that allow for determining a domain name from the extracted elements. DNS reverse cache 126, as explained in more detail below, stores a mapping of IP addresses to domain names.

In some embodiments, PGW 112 also includes DNS proxy 125, HTTP Proxy/TCP Splicing 128, and DNS cache 127. DNS Proxy module 125 inspects the DNS responses to build a database of the DNS requests and responses. When a UE 102 initiates a DNS Request, the DNS Proxy module 125 first inspects the DNS Cache to see if there is a matching entry. If a matching entry is found, the workflow module returns the matching information in a DNS response message. If a matching entry is not found, the DNS Request is sent out to a DNS server. On receipt of the DNS Response, this information is installed in the DNS cache that is maintained by the DNS Proxy module. Any subsequent requests that are received from UEs for this domain will be fulfilled by the information that is available in the DNS Cache 127. TCP Splicing is the functionality that is implemented in the HTTP Proxy module 128 where after setting up two separate TCP connections with UE and Origin Server, the information received on one connection is relayed to the other connection. While FIG. 1 shows each of PCEF 122, DPI engine 124, DNS Reverse Cache 126, DNS proxy 125, HTTP Proxy/TCP Splicing 128, and DNS cache 127 located within PGW 112, each of these elements can also be separate from PGW 112 and operably connected to PGW 112.

Collectively, SGW 118, PGW 112, PCEF 122, DPI engine 124, DNS Reverse Cache 126, DNS proxy 125, HTTP Proxy/TCP Splicing 128, and DNS cache 127 are part of a workflow within mobile content cloud 140. In some embodiments, mobile content cloud 140 virtualizes network elements such that the network elements are scalable based on the parameters specified by a network operator. The processes (e.g., routing of packets) to and from network elements as well as the collection of network elements is referred to herein interchangeably as workflow module (or workflow) 140 and mobile content cloud 140. Mobile content cloud 140, while shown to include PGW 112 and SGW 118 in this embodiment, can also include other network elements, such as MME 106 and PCRF 114.

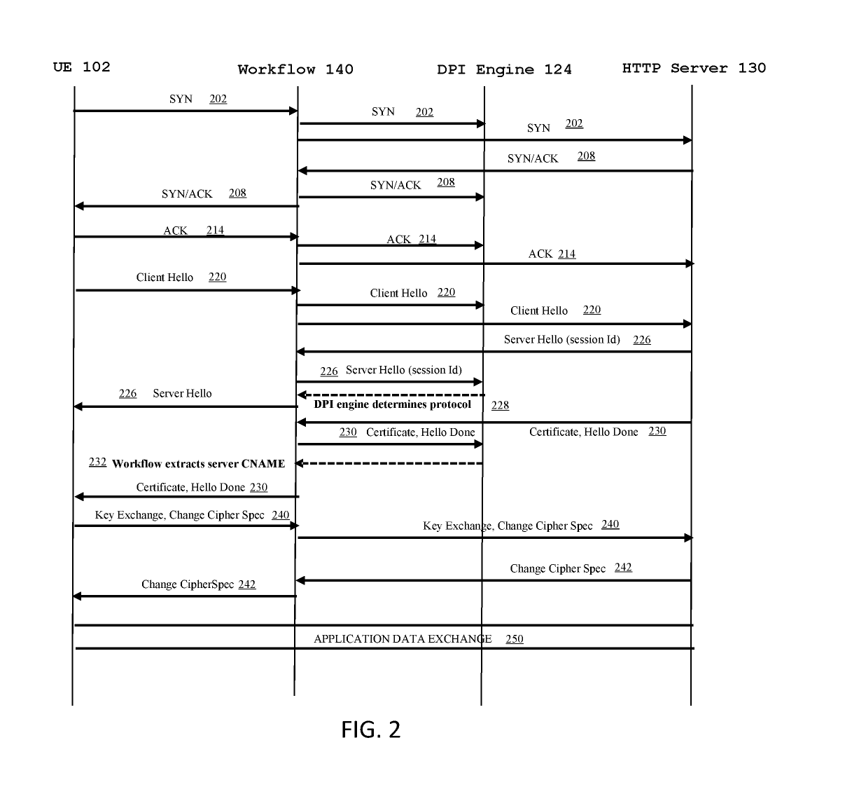

FIG. 2 is a flow diagram showing a TLS message flow between UE and an HTTP server during a full handshake, according to some embodiments of the present disclosure. FIG. 2 shows UE 102, workflow module 140, DPI engine 124, and HTTP server 130, as well as message flows between each of the network elements. TLS message flow between UE 102 and HTTP server 130 includes the following steps: connecting to HTTP server, UE sending list of supported protocols, HTTP server picking a protocol for the session, HTTP server sending a certificate, UE 102 and HTTP server exchanging keys and changing cipher specification, and application data exchange 250.

To connect to the HTTP server 130, UE 102 and HTTP server 130 perform a three-way handshake, which generally involves UE 102 sending a synchronize (SYN) packet to HTTP server 130, HTTP server 130 sending a synchronize/acknowledgement (SYN/ACK) packet to UE 130, and UE 130 sending an ACK packet to HTTP server 130. UE 102 first sends a SYN packet 202 to workflow module 140. Workflow module 140 forwards the SYN packet 202 to HTTP server 130. Workflow module 140 also forwards the SYN packet 202 to DPI engine 124. Next, HTTP server 130 sends a SYN/ACK packet 208 to workflow module 140. Workflow forwards the SYN/ACK packet 208 to UE 102. Workflow also sends the SYN/ACK packet 208 to DPI engine 124. UE 102 then sends an ACK packet 214 to workflow module 140. Workflow module 140 forwards the ACK packet 214 to HTTP server 130. Workflow also forwards the ACK packet 214 to DPI engine 124. UE 102 is now connected to HTTP server 130.

DPI engine 124 detects at least one of a protocol and application within SYN packet 202, SYN/ACK packet 208, and ACK packet 214. In some embodiments, DPI engine 124 examines a few packets of a given connection in order to determine protocol information. For example, DPI engine 124 can determine from packet analysis whether a connection is a TLS connection. In some embodiments, DPI engine 124 returns protocol information only after DPI engine 124 sees a Server Hello packet, as described in more detail below.

Next, UE 102 sends a list of supported protocols to HTTP server 130. First, UE 102 sends a client Hello message 220 to workflow module 140. Client Hello 220 message includes a list of protocols supported by the UE 102. TLS protocol is composed of two layers: TLS Record protocol and TLS Handshake protocol. Client Hello is one of the messages defined in the TLS Handshake protocol. UE 102 sends information such as the TLS protocol version, a list of suggested compression methods and cipher suites in the Client Hello message. Workflow module 140 forwards the client Hello message 220 to HTTP server 130. Workflow also forwards the client Hello message 220 to DPI engine 124. As described above, DPI engine analyzes packets for a protocol and an application. The DPI engine 124 extracts a session ID, if any, that is specified in the Client Hello message. Next, HTTP server 130 sends a Server hello message 226 to workflow module 140. The Server Hello message 226 includes protocols to use for the session as well as a session ID. For example, the Server Hello message 226 includes a chosen protocol version, cipher suite and compression method. In TLS sessions, the session ID is unique. That is, the session ID uniquely identifies the UE and server pair. Servers that implement RFC 5246 complaint session ID based TLS session resumption mechanism, send a unique session id in the Server Hello message. Workflow module 140 sends the hello message 226 to DPI engine 124. DPI engine 124 detects and retrieves the protocol (e.g., SSL) and session ID associated with the hello message 226 and stores the session ID in a cache associated with the workflow. In some embodiments, the cache is maintained in the workflow module 140. Each public data network (PDN) session is anchored on a specific workflow module in the system and packets that belong to a given session are delivered to the workflow module for session related processing. DPI engine 124 provides the protocol information to workflow module 140. Workflow module 140 then forwards the hello message 226 to UE 102, which includes the session ID information.

HTTP server 130 then sends a certificate and hello done message 230 to workflow module 140. Workflow module 140 sends the certificate and server hello done message 230 to DPI engine 124. DPI engine 124 extracts a server canonical name record (CNAME) from the certificate message 230. DPI engine 124 provides the CNAME to workflow module 140. In some embodiments, packets are handed over to the DPI engine 124 by invoking an application programming interface (API). Workflow module 140 extracts fields such as Session Id and Common Name by invoking APIs that are provided by the DPI engine 124. Workflow associates the CNAME with the session ID, and stores the mapping in the cache. Workflow module 140 then forwards the certificate and Server Hello done message 230 to UE 102, which includes the CNAME.

UE 102 then sends ClientKeyExchange and ChangeCipherSpec messages 240 to workflow module 140. In some embodiments, the ChangeCipherSpec message informs the Server that all later messages that are sent by the client are authenticated and encrypted. Workflow module 140 forwards the ClientKeyExchange and ChangeCipherSpec 240 to HTTP server 130. HTTP server 130 then sends ChangeCipherSpec message 242 to workflow module 140. Workflow module 140 then forwards the message 242 to UE 102. Application data can then be exchanged 250 between UE 102 and HTTP server 130.

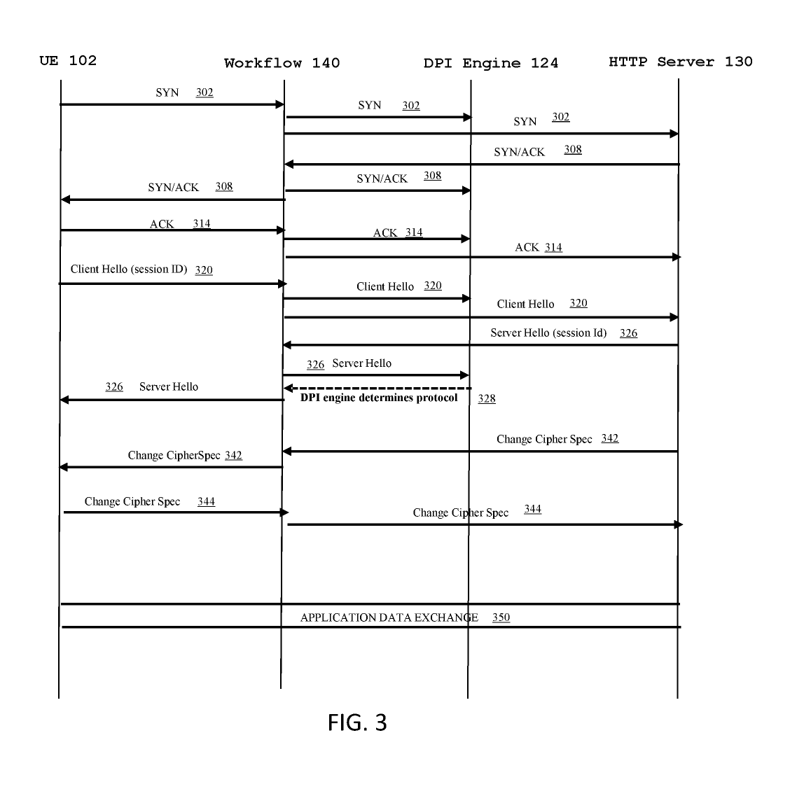

FIG. 3 is a flow diagram showing a TLS message flow between UE and an HTTP server during an abbreviated handshake, according to some embodiments of the present disclosure. FIG. 3 shows UE 102, workflow module 140, DPI engine 124, and HTTP server 130, as well as message flows between each of the network elements. TLS message flow between UE 102 and HTTP server 130 includes the following steps: connecting to HTTP server, UE sending list of supported Cipher suites and Compression methods, HTTP server picking a Cipher suite and compression method for the session, UE 102 and HTTP server 130 exchanging keys and changing cipher specification, and application data exchange 350.

The process of sending and receiving SYN 302, SYN/ACK 308, and ACK 314, between UE 102, workflow module 140, DPI engine 124, and HTTP server 130 are similar to the processes described with respect to SYN 202, SYN/ACK 208, and ACK 214 as described with respect to FIG. 2. The process of DPI engine 124 determining protocol 328, HTTP server 130 sending changed cipher specifications 342 to UE 102, UE 102 sending changed cipher specifications 344 to HTTP server 130, and application data exchange 350 are also similar to the processes described with respect to DPI engine 124 determining protocol 228, HTTP server 130 sending changed cipher specifications 242 to UE 102, UE 102 sending changed cipher specifications 240 to HTTP server 130, and application data exchange 250 as described with respect to FIG. 2.

In the abbreviated handshake example illustrated in FIG. 3, after sending ACK 314 to the HTTP server, UE 102 sends a client hello message 320 to workflow module 140, which includes the session ID that was used in a former full handshake. In some embodiments, if HTTP server 130 does not want to support the TLS session resumption functionality, it does not include the session ID in the ServerHello message. Similarly, if Client does not want to resume a previously established session, it does not include a session ID in the ClientHello message. On receipt of this message at workflow module 140, workflow module 140 forwards the client hello message 320 to DPI engine 124. Workflow module 140 checks its internal TLS session cache to find the corresponding TLS session attributes. Assuming that the workflow does find the corresponding entry in its TLS session cache, it echoes the same session ID in the client hello message 320 to the HTTP server 130. Even if workflow does not find the session ID, the packet is still forwarded to the HTTP server 130. HTTP server 130 sends a server hello message with a session ID 326 to workflow module 140. Workflow module 140 sends the server hello message to DPI engine 124 to determine the session ID. After recognizing the same session ID in the Server Hello message 326, workflow module 140 uses the internal TLS session id cache to map the TLS session ID to the HTTP server CName field even though a certificate message that has this information was not exchanged in this abbreviated TLS handshake. The extracted server CName is then used to search through the rule database in order to apply the server CName based policy actions.

In some embodiments, mobile content cloud 140 supports a construct called a TLS rule group. Each TLS rule group has one or more TLS rule group rules. Each rule can be configured to match against either the SNI or the Server Common Name or both. Mobile content cloud 140 also has another construct called service rule that can include a TLS rule group. Mobile content cloud 140 allows the operator to provision various services like QoS, charging, and metering to all flows that match a service rule. Using the mechanisms that are described in the paragraphs above, mobile content cloud can apply QoS, charging and metering semantics to flows that go through an abbreviated form of TLS handshake (even though a Certificate that has a server Common Name has not been exchanged between the Server and Client for this flow).

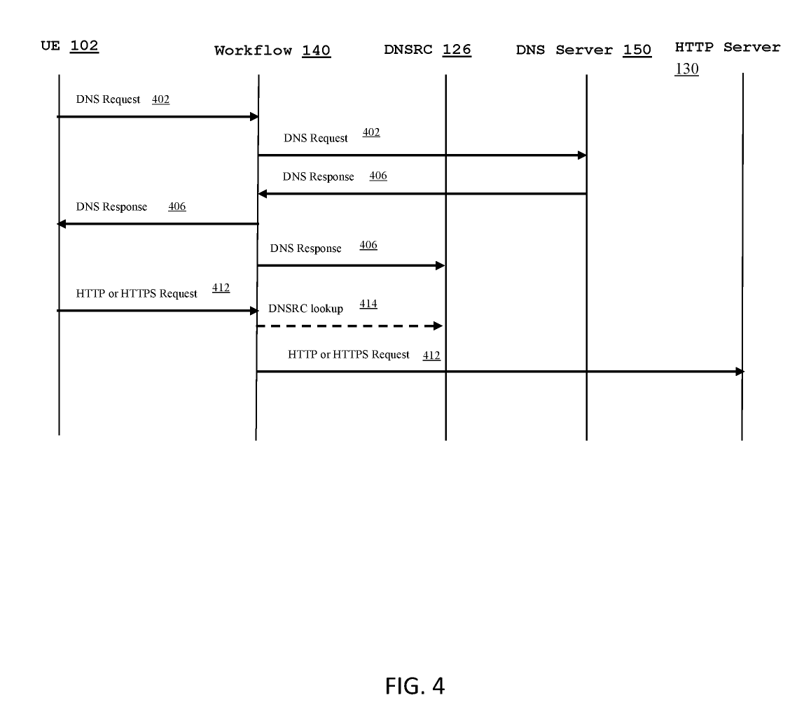

FIG. 4 is a flow diagram showing a DNS request and response that a host exchanges for domain name resolution, according to some embodiments of the present disclosure. FIG. 4 shows UE 102, workflow module 140, DNS reverse cache (DNSRC) 126, DNS server 150, and HTTP server 130 as well as message flows between each of the network elements.

UE 102 sends a DNS request 402 to workflow module 140. Workflow module 140 then sends the DNS request 402 to DNS server 150. DNS server 150 sends DNS response 406 to workflow module 140. Workflow module 140 saves the IP address to domain name mapping associated with the DNS response 406 to DNSRC 126. Workflow module 140 also sends the DNS response 406 to UE 102. When the UE 102 attempts to send a packet associated with an HTTP or HTTPS request 412 to the same HTTP server 130 for which it had earlier resolved the domain name, workflow module 140 uses the destination IP address in the packet as the key to perform a lookup in the DNSRC 414. The matching DNS name is then used to search through the rule database in order to apply the domain rule based policies. Workflow then passes the packet associated with an HTTP or HTTPS request 412 to the HTTP server 130.

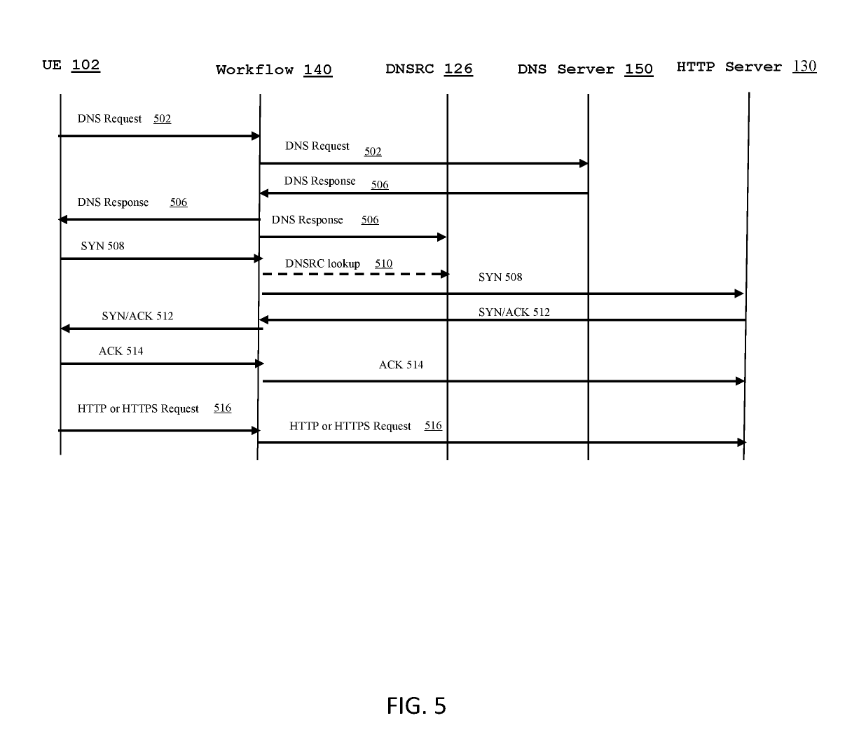

FIG. 5 is a flow diagram showing a combination of DNS reverse caching, TLS domain detection, and deep packet inspection techniques to handle resumed sessions, according to some embodiments of the present disclosure.

The process of transmitting and receiving DNS request 502 and DNS response 506 is substantially similar to the process of transmitting and receiving DNS request 402 and DNS response 406 as described with respect to FIG. 4. Referring to FIG. 5, upon receipt of a SYN packet 508 from UE 102, workflow module 140 performs a lookup in the DNS Reverse Cache (DNSRC) 126 to determine a domain name associated with the received SYN packet 508. Once a domain name is determined, workflow module 140 applies QoS, charging, metering and other services to the flow based on domain name specific policies. The process of transmitting and receiving of SYN packet 508, SNY/ACK 512 and ACK 514 are substantially to the process of transmitting and receiving of SYN packet 302, SNY/ACK 308 and ACK 314, as described with respect to FIG. 3. Referring back to FIG. 5, when workflow module 140 receives either a HTTP (or HTTPS) request in message 516, workflow module 140 hands over the received message to DPI Engine (not shown) and extracts the domain name from HTTP server 130 (or SM in Client Hello in case of HTTPS). The domain name that is retrieved from DPI engine overrides the domain name that was determined using DNSRC lookup 510. If workflow module 140 determines that the domain name is different from what was identified earlier (i.e. with respect to the DNSRC lookup 510), workflow module 140 applies the QoS, charging and metering semantics to the flow based on the new domain name information.

Using the techniques that are described in this invention, workflow module 140 can apply domain specific policies for all types of traffic.
1) For HTTP traffic, the host header in the HTTP request packets is used to extract the domain name. This domain name is then used to determine the specific set of Qos, charging and metering semantics that should be applied to the flow.
2) For HTTPS traffic, the combination of the SNI and the Server Common Name can be used to determine the domain name. This domain name is then used to determine the specific set of Qos, charging and metering semantics that should be applied to the flow.
3) For all other types of traffic (also referred to herein as non HTTP or HTTPS traffic), the destination IP address in the packet is used as the lookup key in order to search the DNSRC (DNS Reverse Cache) and find the corresponding domain name. This domain name is then used to determine the specific set of Qos, charging and metering semantics that should be applied to the flow. Examples of non HTTP or HTTPS traffic include Internet Control Message Protocol (ICMP), User Datagram Protocol (UDP), and non-HTTP protocols using Transmission Control Protocol (TCP).

In some embodiments, techniques are disclosed for integrating a TCP and DNS Proxy that is anchored on a GGSN/WAG/PGW. For each of the domains that require distinctive treatment, the DNS proxy is configured to respond with the local IP address of the gateway. For example, if https://www.foo.com is free rated and steered to a set of servers, the DNS proxy can be configured to return the IP address of the gateway IP address and the TCP Proxy will be configured to steer the traffic based on TLS handshake parameters (SNI) and the certificate alt names and common names. The charging policies in the gateway can be configured to free rate any traffic going to the IP address of the gateway, which allows free rating rules to function more reliably.

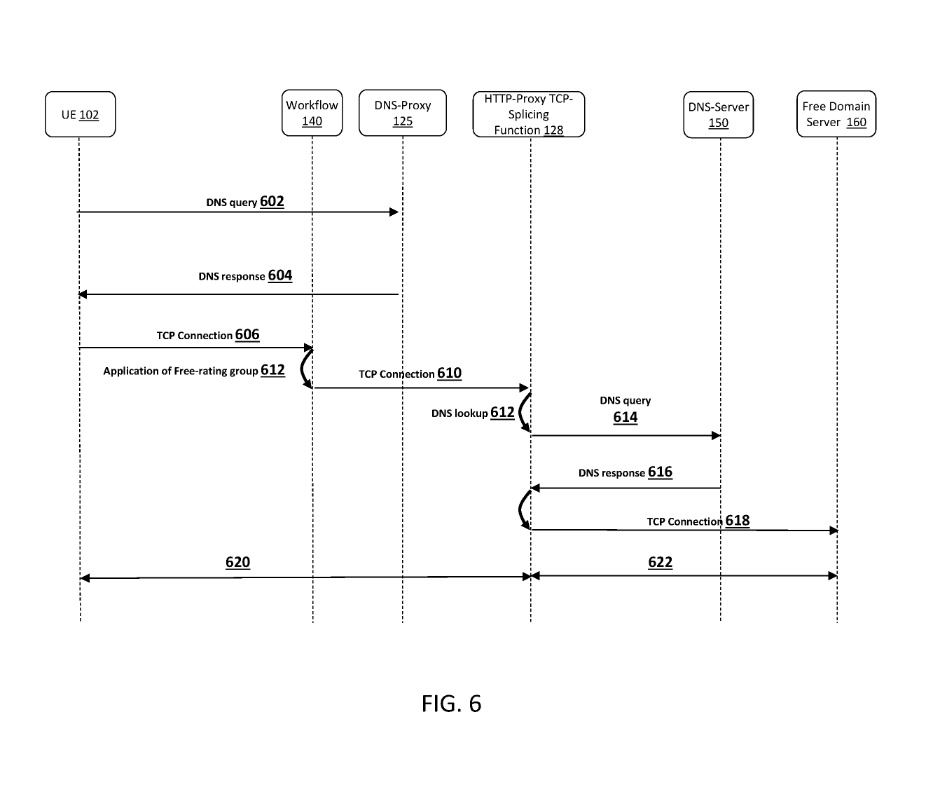

FIG. 6 is a flow diagram showing routing of free-rated traffic using service differentiation TCP splicing, according to some embodiments, of the present disclosure.

In some embodiments, the elements in the workflow module 140 are configured in the following manner:
1) A separate loopback IP address is configured for each free rated domain. A loopback IP address refers generally to an IP address that is associated with a free rated domain. The mapping between the loopback IP address and the free rated domain is stored in the DNS cache 127.
2) Workflow is configured to free rate all the traffic that matches any one of the loopback IP addresses that are configured in the DNS cache 127.
3) HTTP proxy is configured to apply TCP splicing functionality of HTTP Proxy for the traffic that matches each one of the loopback IP addresses that are configured in the DNS cache 127.
4) Workflow is configured with a static DNS mapping between each free domain to the corresponding loopback IP address.

UE 102 sends a DNS query 602 to DNS proxy 125. DNS query 602 can include a domain name associated with a free-rated IP address (e.g., freedomain.com). In response to the DNS 602, DNS proxy 125 sends a DNS response 604 back to UE 102. In some embodiments, the DNS response 604 includes a designated workflow module loopback address for the free domain from a static DNS map (e.g., freedomain.com=AAAA 2001::AFFD:1). As described above, the DNS cache 127 is configured with a static DNS mapping between each free domain to the corresponding loopback address. UE 102 then attempts to establish a TCP connection 606 with the IP address that was returned in the DNS response (which in this case is a loopback IP address that is configured on MCC) (e.g., UE->[2001::AFFD:1]:443). The TCP connection 606 request is routed to workflow 140, which applies a free rating group for the connection and assigns the designated loopback address to the connection 608. Charging 114 then routes the TCP connection request including the loopback address 610 to HTTP proxy/TCP splicing function 128. HTTP proxy/TCP splicing function 128 performs a DNS lookup on the free rated domain that corresponds to the loopback IP address. Specifically, in some embodiments, HTTP proxy/TCP splicing function 128 finds a policy for connections received with a designated loopback address and looks at its configuration and sends a DNS query for the configured free domain name 612. Upon receipt of the DNS query 614 at DNS server 150, DNS Server 150 returns the IP address of the free rated domain server in the DNS response 616 (e.g., freedomain.com=AAAA 2001::ABC1). After receiving the DNS response, HTTP proxy/TCP splicing function 128 establishes another TCP connection with the free rated domain server 618 (e.g., HTTP-Proxy->[2001::ABC1]:443). HTTP proxy/TCP splicing function 128 then performs TCP splicing by forwarding all packets that are received on the TCP connection with UE 102 to the TCP connection 618 with the free rated domain server 160 and forwarding all packets that are received on the TCP connection from free domain server 160 to UE 102 620 622.

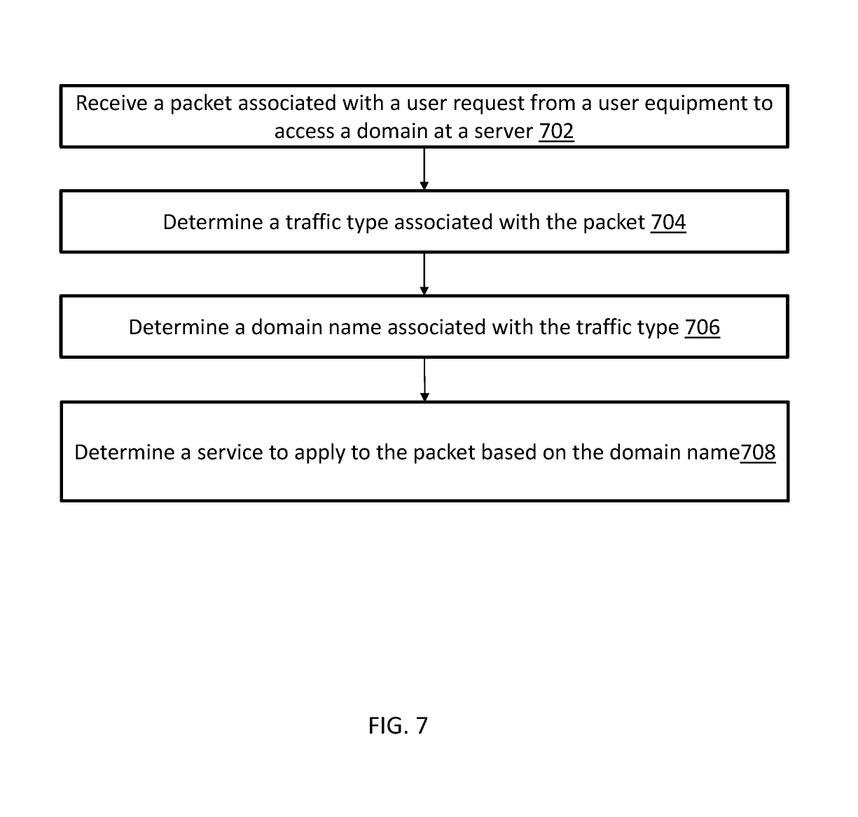

FIG. 7 shows a flowchart of detecting a domain name in a mobile network session to apply a service to the session, according to some embodiments of the present disclosure.

Referring to step 702, a packet associated with a request from a user equipment to access a domain at a server is received. In some embodiments, the request is received at a computing device. In some embodiments the computing device includes a workflow module. As described above, in some embodiments, the workflow module is a mobile content cloud that virtualizes mobile functions such as the PGW and SGW.

Referring to step 704, a traffic type associated with the packet is determined. In some embodiments, the traffic type includes at least one of HTTP traffic, HTTPS traffic, and non HTTP/HTTPS traffic. As described above, a workflow module can determine a traffic type by performing shallow packet inspection, which is the logic to inspect the layer-3 and layer-4 headers in the IP packets, as well as deep packet inspection to figure out the traffic type.

Referring to step 706, a domain name based on the traffic type is determined. In some embodiments, determining the domain name includes extracting a domain name from a host header in the packet when the traffic type comprises HTTP traffic, extracting a server name indication (SNI) and a server common name from the packet to determine a domain name when the traffic type comprises HTTPS traffic, and extracting a destination IP address from the packet, and using the destination IP address to determine a matching domain name in a DNS reverse cache when the traffic type comprises non HTTP/HTTPS traffic. In some embodiments, when the packet is associated with HTTPS traffic, the domain name is determined differently based on a handshake status. For example, if the session is associated with a full handshake, at least one of the SNI and the server common name from the packet can be extracted to determine the domain name. In some embodiments, the SNI and server common name can be associated with a session ticket and the correlation between the session ticket and server common name stored locally at the workflow module. Handshakes occurring after the full handshake can be abbreviated and may not include the SNI or server common name information. When the SNI information is available, the SNI information can be extracted and used to determine the domain name. When the SNI information is not available, the session ticket associated the abbreviated session can be compared with a previously generated session ticket a created during a previous full handshake between the user equipment and the server, the previously generated session ticket associated with the server common name.

Referring to step 708, a service to apply to the packet is determined based on the domain name. In some embodiments, the service includes at least one of a quality of service (Qos), charging semantics, and metering semantics. As described above, information about services to be applied to packets can be stored in a database and correlated with a domain name. By using the methods described herein for determining domain names for different traffic types, an operator can provision services for a greater number of flows.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A computerized method of detecting a domain name in a mobile network session for use in applying mobile policy and enforcement functions based on the domain name, the method comprising:
receiving, at a computing device, a packet associated with a request from a user equipment to access a domain at a server;
determining, at the computing device, a traffic type associated with the packet, the traffic type including one of Hypertext Transfer Protocol (HTTP) traffic, Hypertext Transfer Protocol Secure (HTTPS) traffic, and non HTTP or HTTPS traffic;
determining, at the computing device, a domain name based on the traffic type, wherein determining the domain name comprises:
extracting, by the computing device, a domain name from a host header in the packet when the traffic type comprises HTTP traffic, extracting, by the computing device, at least one of a server name indication (SNI) and a server common name from the packet to determine a domain name when the traffic type comprises HTTPS traffic, and
extracting, by the computing device, a destination IP address from the packet, and using the destination IP address to determine a matching domain name in a DNS reverse cache when the traffic type comprises non HTTP or HTTPS traffic; and
determining, at the computing device, a service to apply to the packet based on the domain name.

2. The method of claim 1, further comprising:
storing, by the computing device, an association between the domain name with at least one of:
an Internet Protocol (IP) address, and
a transport layer security session ID.

3. The method of claim 1, further comprising applying, by the computing device, deep packet inspection to the packet to determine the traffic type.

4. The method of claim 1, further comprising:
transmitting, by the computing device, a loopback address to the user equipment indicative of the domain name.

5. The method of claim 1, wherein the service comprises at least one of a quality of service (Qos), charging semantics, and metering semantics.

6. The method of claim 1, wherein non HTTP or HTTPS traffic comprises at least one of Internet Control Message Protocol (ICMP) traffic, User Datagram Protocol (UDP) traffic, and non-HTTP protocols using Transmission Control Protocol (TCP) traffic.

7. The method of claim 1, wherein determining the domain name further comprises when the traffic type comprises HTTPS traffic:
determining, by the computing device, a handshake status between the user equipment and the server, the handshake status including one of a full handshake and an abbreviated handshake;
when the handshake status comprises a full handshake:
extracting, by the computing device, at least one of the SNI and the server common name from the packet to determine the domain name; and
when the handshake status comprises an abbreviated handshake:
extracting, by the computing device, the SNI from the packet when the SNI is available, and
determining, by the computing device, the server common name when the SNI is unavailable, wherein determining the server common name comprises:
extracting, by the computing device, a session ticket associated with the request, and
comparing, by the computing device, the session ticket with a previously generated session ticket created during a previous full handshake between the user equipment and the server, the previously generated session ticket associated with the server common name.

8. A computing device for detecting a domain name in a mobile network session for use in applying mobile policy and enforcement functions based on the domain name, the computing device comprising:
data storage; and
a processor in communication with the data storage, and configured to run a module stored in memory that is configured to cause the processor to:
receive a packet associated with a request from a user equipment to access a domain at a server;
determine a traffic type associated with the packet, the traffic type including one of Hypertext Transfer Protocol (HTTP) traffic, Hypertext Transfer Protocol Secure (HTTPS) traffic, and non HTTP or HTTPS traffic;
determine a domain name based on the traffic type, wherein to determine the domain name, the processor is further caused to:
extract a domain name from a host header in the packet when the traffic type comprises HTTP traffic,
extract at least one of a server name indication (SNI) and a server common name from the packet to determine a domain name when the traffic type comprises HTTPS traffic, and
extract a destination IP address from the packet, and using the destination IP address to determine a matching domain name in a DNS reverse cache when the traffic type comprises non HTTP or HTTPS traffic; and
determine a service to apply to the packet based on the domain name.

9. The computing device of claim 8, wherein the processor is further caused to:
store an association between the domain name with at least one of:
an Internet Protocol (IP) address, and
a transport layer security session ID.

10. The computing device of claim 8, wherein the processor is further caused to:
apply deep packet inspection to the packet to determine the traffic type.

11. The computing device of claim 8, wherein the processor is further caused to:
transmit a loopback address to the user equipment indicative of the domain name.

12. The computing device of claim 8, wherein the service comprises at least one of a quality of service (Qos), charging semantics, and metering semantics.

13. The computing device of claim 8, wherein non HTTP or HTTPS traffic comprises at least one of Internet Control Message Protocol (ICMP) traffic, User Datagram Protocol (UDP) traffic, and non-HTTP protocols using Transmission Control Protocol (TCP) traffic.

14. The computing device of claim 8, wherein to determine the domain name when the traffic type comprises HTTPS traffic, the processor is further caused to:
determine a handshake status between the user equipment and the server, the handshake status including one of a full handshake and an abbreviated handshake;
when the handshake status comprises a full handshake:
extract at least one of the SNI and the server common name from the packet to determine the domain name; and
when the handshake status comprises an abbreviated handshake:
extract the SNI from the packet when the SNI is available, and
determine the server common name when the SNI is unavailable, wherein determining the server common name comprises:
extracting a session ticket associated with the request, and
comparing the session ticket with a previously generated session ticket created during a previous full handshake between the user equipment and the server, the previously generated session ticket associated with the server common name.

15. A non-transitory computer readable medium having executable instructions operable to cause an apparatus to:
receive a packet associated with a request from a user equipment to access a domain at a server;
determine a traffic type associated with the packet, the traffic type including one of Hypertext Transfer Protocol (HTTP) traffic, Hypertext Transfer Protocol Secure (HTTPS) traffic, and non HTTP or HTTPS traffic;
determine a domain name based on the traffic type, wherein to determine the domain name the apparatus is further caused to:
extract a domain name from a host header in the packet when the traffic type comprises HTTP traffic,
extract at least one of a server name indication (SNI) and a server common name from the packet to determine a domain name when the traffic type comprises HTTPS traffic, and
extract a destination IP address from the packet, and using the destination IP address to determine a matching domain name in a DNS reverse cache when the traffic type comprises non HTTP or HTTPS traffic; and
determine a service to apply to the packet based on the domain name.

16. The non-transitory computer readable medium of claim 15, wherein the apparatus is further caused to:
store an association between the domain name with at least one of:
an Internet Protocol (IP) address, and
a transport layer security session ID.

17. The non-transitory computer readable medium of claim 15, wherein the apparatus is further caused to:
apply deep packet inspection to the packet to determine the traffic type; and
transmit a loopback address to the user equipment indicative of the domain name.

18. The non-transitory computer readable medium of claim 15, wherein the service comprises at least one of a quality of service (Qos), charging semantics, and metering semantics.

19. The non-transitory computer readable medium of claim 15, wherein non HTTP or HTTPS traffic comprises at least one of Internet Control Message Protocol (ICMP) traffic, User Datagram Protocol (UDP) traffic, and non-HTTP protocols using Transmission Control Protocol (TCP) traffic.

20. The non-transitory computer readable medium of claim 15, wherein to determine the domain name when the traffic type comprises HTTPS traffic, the apparatus is further caused to:
determine a handshake status between the user equipment and the server, the handshake status including one of a full handshake and an abbreviated handshake;
when the handshake status comprises a full handshake:
extract at least one of the SNI and the server common name from the packet to determine the domain name; and
when the handshake status comprises an abbreviated handshake:
extract the SNI from the packet when the SNI is available, and
determine the server common name when the SNI is unavailable, wherein determining the server common name comprises:
extracting a session ticket associated with the request, and
comparing the session ticket with a previously generated session ticket created during a previous full handshake between the user equipment and the server, the previously generated session ticket associated with the server common name.
